(19) United States
(12) Patent Application Publication
(10) Pub. No.: US 2026/0301689 A1
(43) Pub. Date: Oct. 1, 2026

(54) GATE DRIVING CIRCUIT AND DISPLAY PANEL

(71) Applicant: HKC CORPORATION LIMITED, SHENZHEN (CN)

(72) Inventors: Xiao ZHAO, SHENZHEN (CN); Rui JIANG, SHENZHEN (CN); Pei XU, SHENZHEN (CN)

(21) Appl. No.: 19/570,223

(22) Filed: Mar. 18, 2026

(30) Foreign Application Priority Data
Apr. 1, 2025 (CN) 202510404264.1

(51) Int. Cl. G09G 3/3266

(52) U.S. Cl. CPC G09G 3/3266; G09G 2310/0286

(57) ABSTRACT

The present application provides a gate driving circuit and a display panel. The gate driving circuit includes a plurality of gate driving units connected in cascades. Each of the gate driving units at least includes: a cascade driving unit, connected to a previous-stage gate driving unit; a first output unit, connected to the cascade driving unit and configured to output a first pulse signal, the first pulse signal being a low-potential pulse signal with a normal high potential; a second output unit, connected to the cascade driving unit and configured to output a second pulse signal, the second pulse signal being a high-potential pulse signal with a normal low potential. An output of different scanning signals may be realized through the above circuit.

### CROSS REFERENCE TO RELATED APPLICATIONS

The present disclosure claims priority to Chinese Patent Application No. 202510404264.1, filed on Apr. 1, 2025, the entire contents of which are incorporated herein by reference.

### TECHNICAL FIELD

The present disclosure relates to the field of display panels, and in particular to a gate driving circuit and a display panel.

### BACKGROUND

With the development of display technology, organic light emitting display (OLED) has become mainstream in a small-size display market. A small-size OLED display product typically adopts a gate on array (GOA) circuit to generate and process scanning signals required by a pixel driving circuit.

To achieve a low refresh rate function, it is theoretically necessary to extend a holding time of a voltage at a gate terminal of a driving transistor. Currently, a mainstream solution involves introducing a new material with lower Ioff (leakage current) characteristics, such as indium gallium zinc oxide (hereinafter referred to as IGZO), to fabricate transistors, or using a phosphorus channel doping process to fabricate different types of transistors.

To further reduce leakage current, an N-type transistor (NMOS) with lower carrier mobility is fabricated by implanting phosphorus (P) into an IGZO-based MOS (transistor). The driving of NMOS requires a positive pulse, which is opposite to a P-type transistor (PMOS). Therefore, in GOA circuit design, in addition to a switch pulse (EM) and a low-level pulse (Pscan), an additional set of GOA circuit for generating a high-level pulse (Nscan) needs to be designed. However, the additional set of GOA circuit for generating a high-level pulse may occupy a large amount of border area.

### SUMMARY

A first aspect of the present disclosure may provide a gate driving circuit. The gate driving circuit may include a plurality of gate driving units connected in cascades. Each of the gate driving units at least may include: a cascade driving unit, connected to a previous-stage gate driving unit; a first output unit, connected to the cascade driving unit and configured to output a first pulse signal, the first pulse signal being a low-potential pulse signal with a normal high potential; a second output unit, connected to the cascade driving unit and configured to output a second pulse signal, the second pulse signal being a high-potential pulse signal with a normal low potential.

A second aspect of the present disclosure may provide a display panel. The display panel may include the gate driving circuit according to the first aspect.

### BRIEF DESCRIPTION OF THE DRAWINGS

In order to describe the technical solutions of some embodiments of the present disclosure more clearly, a brief introduction may be given below to the drawings that are required in the description of the embodiments. It is apparent that the drawings described below merely illustrate some embodiments of the present disclosure. Other drawings may further be obtained by those skilled in the art without inventive effort based on these drawings.

FIG. 1 is a schematic structural view of a gate driving circuit according to some embodiments of the present disclosure.

FIG. 2 is a timing signal view of a first pulse signal and a second pulse signal according to some embodiments of the present disclosure.

FIG. 3 is a schematic structural view of a gate driving unit according to a first embodiment of the present disclosure.

FIG. 4 is a schematic structural view of a gate driving unit according to a second embodiment of the present disclosure.

FIG. 5 is a schematic structural view of a gate driving unit according to a third embodiment of the present disclosure.

FIG. 6 is a schematic structural view of a gate driving unit according to a fourth embodiment of the present disclosure.

FIG. 7 is a schematic structural view of a gate driving unit according to a fifth embodiment of the present disclosure.

FIG. 8 is a schematic circuit structural view of a gate driving unit according to a sixth embodiment of the present disclosure.

FIG. 9 is a driving timing view of the gate driving unit according to the sixth embodiment of the present disclosure.

FIG. 10 is a circuit view of a first driving phase of the gate driving unit according to the sixth embodiment of the present disclosure.

FIG. 11 is a circuit view of a second driving phase of the gate driving unit according to the sixth embodiment of the present disclosure.

FIG. 12 is a circuit view of a third driving phase of the gate driving unit according to the sixth embodiment of the present disclosure.

FIG. 13 is a circuit view of a fourth driving phase of the gate driving unit according to the sixth embodiment of the present disclosure.

FIG. 14 is a circuit view of a fifth driving phase of the gate driving unit according to the sixth embodiment of the present disclosure.

FIG. 15 is a schematic structural view of a display panel according to some embodiment of the present disclosure.

first output unit 10; second output unit 20; cascade driving unit 30; previous-stage first pulse signal Pscan(n-1); first pulse signal Pscan(n); second pulse signal Nscan(n);
first control unit 11; second control unit 12; third control unit 21; fourth control unit 22; high-potential power line VGH; low-potential power line VGL; first sub-control unit 121; second sub-control unit 122;
first cascade unit 311; first storage unit C1; first storage output unit 312; second storage unit C2; second storage output unit 321; pull-down unit 322; pull-up unit 323; first sub-pull-up unit 31; second sub-pull-up unit 32; first resistor R1; second resistor R2; charging control unit 324;
first driving signal line XCK; second driving signal line CK; third storage unit C3; second cascade unit 331; third cascade unit 332; first switch unit 221; second switch unit 222;
first transistor T1; second transistor T2; third transistor T3; fourth transistor T4; low-potential signal line VGL1; fifth transistor T5; high-potential signal line VGH1; sixth transistor T6; seventh transistor T7; eighth transistor T8; ninth transistor T9; tenth transistor T10; eleventh transistor T11; twelfth transistor T12; thirteenth transistor T13; fourteenth transistor T14; fifteenth transistor T15;
display panel 100; display area 101; non-display area 102.

### DETAILED DESCRIPTION

The technical solutions of the embodiments of the present disclosure will be described clearly and completely below in conjunction with the accompanying drawings of the embodiments of the present disclosure. It is apparent that the embodiments described are merely a part of the embodiments of the present disclosure, rather than all of the embodiments. Based on the embodiments of the present disclosure, all other embodiments obtained by those skilled in the art without inventive effort shall fall within the protection scope of the present disclosure.

Terms used in the embodiments of the present disclosure are only for the purpose of describing the embodiments, and are not intended to limit the present disclosure. Terms with singular forms such as “a”, “said”, and “the” used in the embodiments of the present disclosure and the appended claims are also intended to include plural forms, unless the specification clearly may indicate otherwise. The term “multiple” generally includes at least two, but does not exclude a case of including at least one.

It should be understood that the term “and/or” used in the specification is only an association relationship describing associated objects, indicating that there may be three relationships. For example, A and/or B may represent three cases: A exists alone, A and B exist simultaneously, and B exists alone. In addition, the character “/” herein generally may indicate that the associated objects adjacent to each other are in an “or” relationship. The terms “first”, “second”, and etc. in the specification, claims, and the accompanying drawings of the present disclosure are used to distinguish similar objects, and are not necessarily used to describe a specific sequence or order.

It should be noted that if there are directional indications (e.g., up, down, left, right, front, back, etc.) in the embodiments of the present disclosure, the directional indications may be used only to explain the relative positional relationships or motion conditions of the components under a certain posture. When the posture changes, the corresponding directional indications may be changed accordingly.

It should be understood that the terms “include”, “comprise” or any other variation thereof used in the specification are intended to cover non-exclusive inclusion, so that a process, method, article, or device including a series of elements not only includes those elements, but also includes other elements not explicitly listed, or elements inherent to the process, method, article, or device. Without further limitations, an element defined by the phrase “include . . . ” does not exclude the presence of other identical elements in the process, method, article, or device including the element.

It should be noted that if there are directional indications (such as up, down, left, right, front, back . . . ) in the embodiments of the present disclosure, the directional indications are only used to explain the relative positional relationship and movement between various components in a specific posture (as shown in the accompanying drawings). If the specific posture changes, the directional indications also change accordingly.

The term “embodiment” mentioned in the specification means that particular features, structures, or characteristics described in conjunction with the embodiments may be included in at least one embodiment of the present disclosure. This term appearing in various positions in the specification does not necessarily refer to the same embodiment, nor is it an independent or alternative embodiment mutually exclusive with other embodiments. Those skilled in the art explicitly or implicitly understand that the embodiments described in the specification may be combined with other embodiments.

It should be noted that a high-potential power line VGH may also refer to a high-potential signal line, configured to transmit a high-potential signal. A low-potential power line VGL may also refer to a low-potential signal line, configured to transmit a low-potential signal. The high-potential signal may also refer to a high-potential voltage or a high-potential level. The low-potential signal may also refer to a low-potential voltage or a low-potential level. An input terminal of a transistor may also be a source of the transistor, an output terminal of the transistor may also be a drain of the transistor, and a control terminal of the transistor may also be a gate of the transistor. The source and the drain of the transistor may be interchanged. The turn-off, shutdown, cut-off, or disconnection of the transistor may have the same meaning.

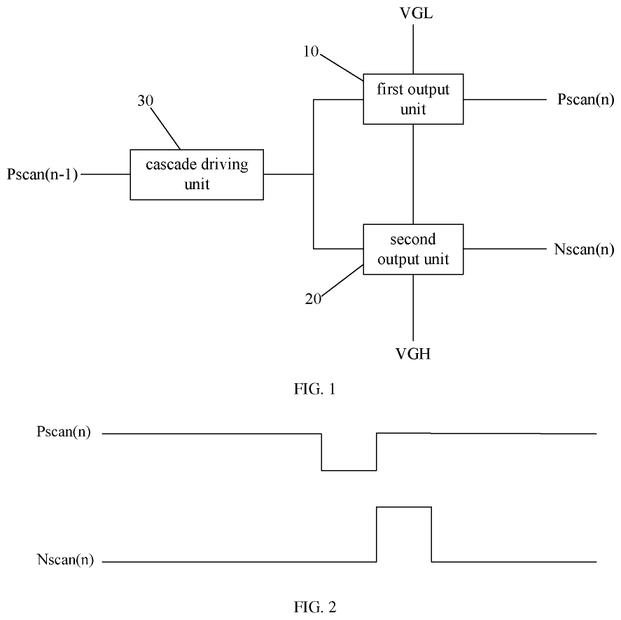

The present disclosure may provide a gate driving circuit. The gate driving circuit may include a plurality of gate driving units connected in cascades. As shown in FIG. 1, FIG. 1 is a schematic structural view of a gate driving circuit according to some embodiments of the present disclosure. As shown in FIG. 1, each of the gate driving units may include at least a first output unit 10, a second output unit 20, and a cascade driving unit 30.

The cascade driving unit 30 may be configured to be connected to a previous-stage gate driving unit. The cascade driving unit 30 of an N-th stage gate driving unit GOA(n) may be connected to an output terminal of the first output unit 10 of a (N−1)-th stage gate driving unit GOA(n-1), that is, connected to a previous-stage first pulse signal Pscan(n-1). A low-potential pulse of the previous-stage first pulse signal Pscan(n-1) may function as a trigger signal and a pull-down signal to initiate an operation of the N-th stage gate driving unit GOA(n). It should be noted that most of the transistors in the embodiments may be P-type transistors that are turned on or conducted at low potential. Therefore, an input terminal of the cascade driving unit 30 may be connected to the previous-stage first pulse signal Pscan(n-1). In other embodiments, the input terminal of the cascade driving unit 30 may also be connected to a previous-stage second pulse signal Nscan(n-1), that is, the cascade driving unit 30 of the N-th stage gate driving unit GOA(n) may be connected to the first output unit 10 of the (N−1)-th stage gate driving unit GOA(n-1), which is not limited herein and may be designed according to actual conditions.

The first output unit 10 may be connected to the cascade driving unit 30 and configured to output a first pulse signal Pscan(n). The first pulse signal Pscan(n) may be a low-potential pulse signal with a normal high potential. The low-potential pulse signal with a normal potential may refer to a signal that is normally at a high level and outputs a low-level pulse signal at a specific moment, where the low-level pulse signal is active/valid. A control terminal of the first output unit 10 may be connected to the cascade driving unit 30, and input terminals of the first output unit 10 may be respectively connected to the high-potential power line VGH and the low-potential power line VGL, which may be configured to generate the first pulse signal Pscan(n).

The second output unit 20 may be connected to the cascade driving unit 30 and configured to output a second pulse signal Nscan(n). The second pulse signal Nscan(n) may be a high-potential pulse signal with a normal low potential. The high-potential pulse signal with a normal low potential may refer to a signal that is normally at a low level and outputs a high-level pulse signal at a specific moment, where the high-level pulse signal is active/valid. A control terminal of the second output unit 20 may be connected to the cascade driving unit 30, and input terminals of the second output unit 20 may be respectively connected to the high-potential power line VGH and the low-potential power line VGL, which may be configured to generate the second pulse signal Nscan(n).

As shown in FIG. 2, FIG. 2 is a timing signal view of a first pulse signal and a second pulse signal according to some embodiments of the present disclosure. As shown in FIG. 2, the first pulse signal Pscan(n) may be a low-potential pulse signal with a normal high potential. The second pulse signal Nscan(n) may be a high-potential pulse signal with a normal low potential. A low potential of the first pulse signal Pscan(n) may come from a low-potential power supply, and a high potential of the first pulse signal Pscan(n) may come from a high-potential power supply, so a more stable and high-quality low-potential pulse signal may be provided. A low potential of the second pulse signal Nscan(n) may come from a low-potential power supply, and a high potential of the second pulse signal Nscan(n) may come from the previous-stage first pulse signal Pscan(n-1) and a high-potential power supply.

In some embodiments, a pulse timing of the second pulse signal Nscan(n) may be delayed relative to a pulse timing of the first pulse signal Pscan(n). In the embodiments, the pulse timing of the second pulse signal Nscan(n) may be delayed by one timing compared with the pulse timing of the first pulse signal Pscan(n). A start time of the high-potential pulse signal of the second pulse signal Nscan(n) may coincide exactly with an end time of the low-potential pulse signal of the first pulse signal Pscan(n). In other embodiments, the pulse timing of the second pulse signal Nscan(n) may also be delayed by multiple timings compared with the pulse timing of the first pulse signal Pscan(n). In other embodiments, the pulse timing of the first pulse signal Pscan(n) may be delayed relative to the pulse timing of the second pulse signal Nscan(n), which may be designed based on a model of a thin film transistor.

A first pulse signal Pscan(n) output by the N-th stage gate driving unit GOA(n) may be delayed by one timing compared with a first pulse signal Pscan(n-1) output by the (N−1)-th stage gate driving unit GOA(n-1). A second pulse signal Nscan(n) output by the N-th stage gate driving unit GOA(n) may be delayed by one timing compared with a second pulse signal Nscan(n-1) output by the (N−1)-th stage gate driving unit GOA(n-1). In this way, gate scanning signals may be provided to each row of a display panel in sequence.

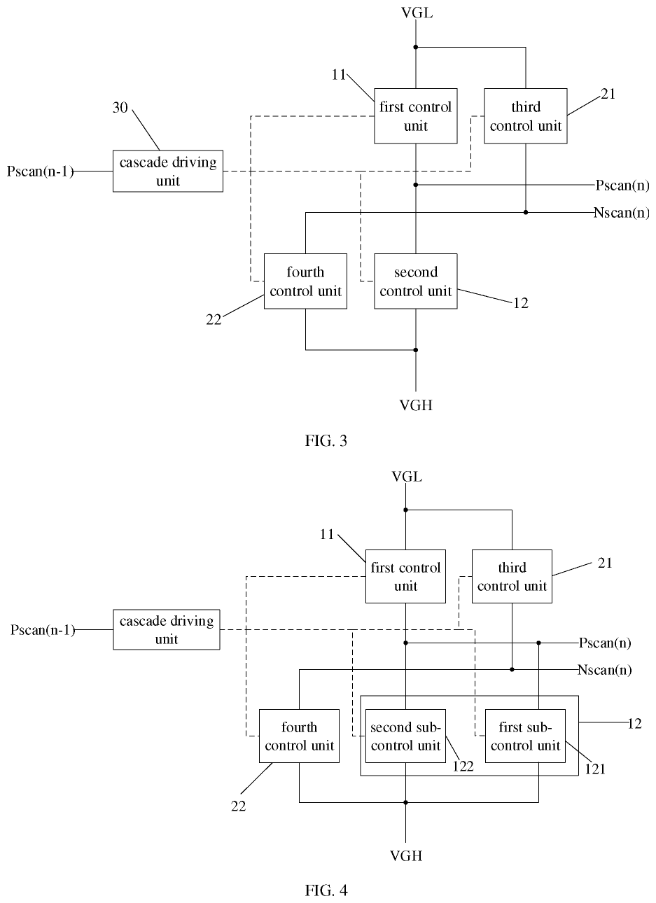

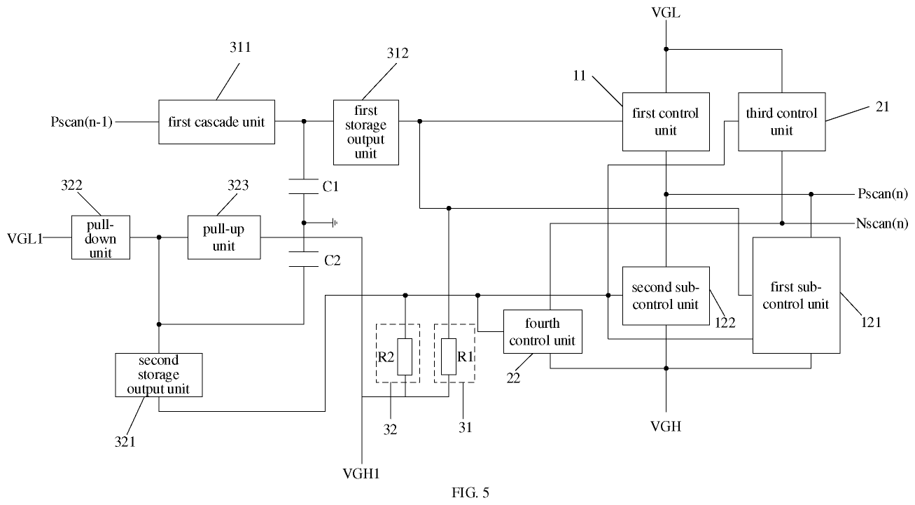

As shown in FIG. 3, FIG. 3 is a schematic structural view of a gate driving unit according to a first embodiment of the present disclosure. As shown in FIG. 3, the first output unit 10 may include a first control unit 11 and a second control unit 12. An input terminal of the first control unit 11 may be connected to the low-potential power line VGL, and the first output unit 10 may be configured to control the first output unit 10 to output a low-potential signal. An input terminal of the second control unit 12 may be connected to the high-potential power line VGH, and the second control unit 12 may be configured to control the first output unit 10 to output a high-potential signal. Control terminals of the first control unit 11 and the second control unit 12 may be connected to the cascade driving unit 30. The cascade driving unit 30 may control the first control unit 11 and the second control unit 12 to be alternately turned on to control the first output unit 10 to output the first pulse signal Pscan(n). The first control unit 11 and the second control unit 12 being alternately turned on may mean that the first control unit 11 and the second control unit 12 are not turned on simultaneously, with the second control unit 12 turned on most of the time.

The second output unit 20 may include a third control unit 21 and a fourth control unit 22. An input terminal of the third control unit 21 may be connected to the low-potential power line VGL, and the third control unit 21 may be configured to control the second output unit 20 to output a low-potential signal. An input terminal of the fourth control unit 22 may be connected to the high-potential power line VGH, and the fourth control unit 22 may be configured to control the second output unit 20 to output a high-potential signal. Control terminals of the third control unit 21 and the fourth control unit 22 may be connected to the cascade driving unit 30. The cascade driving unit 30 may control the third control unit 21 and the fourth control unit 22 to be alternately turned on to control the second output unit 20 to output the second pulse signal Nscan(n). The third control unit 21 and the fourth control unit 22 being alternately turned on may mean that the third control unit 21 and the fourth control unit 22 are not turned on simultaneously, with the third control unit 21 turned on most of the time.

It should be noted that the cascade driving unit 30 may be connected to the control terminals of the first control unit 11, the second control unit 12, the third control unit 21, and the fourth control unit 22, as shown by dotted lines in FIG. 3. The cascade driving unit 30 may be configured to control the turn-on or turn-off of the first control unit 11, the second control unit 12, the third control unit 21, and the fourth control unit 22. Each of the first control unit 11, the second control unit 12, the third control unit 21, and the fourth control unit 22 may include one or more thin film transistors TFTs. The thin film transistors TFTs may include a P-type transistor and an N-type transistor, which are not limited herein.

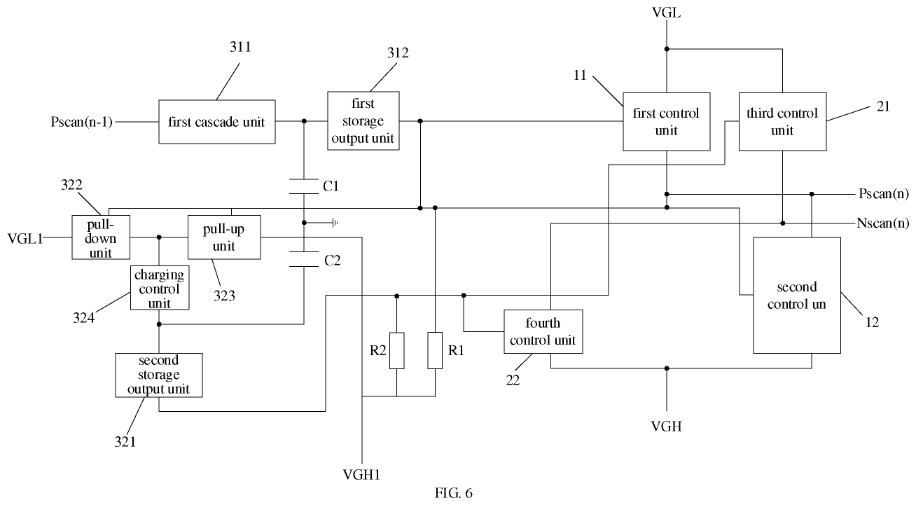

As shown in FIG. 4, FIG. 4 is a schematic structural view of a gate driving unit according to a second embodiment of the present disclosure. As shown in FIG. 4, the second control unit 12 may further include a first sub-control unit 121 and a second sub-control unit 122. Input terminals of the first sub-control unit 121 and the second sub-control unit 122 may be both connected to the high-potential power line VGH. Control terminals of the first sub-control unit 121 and the second sub-control unit 122 may be both connected to the cascade driving unit 30. The first sub-control unit 121 and the second sub-control unit 122 may cooperate to control the first output unit 10 to output the first pulse signal Pscan(n). The first sub-control unit 121 and the second sub-control unit 122 may not be turned on simultaneously.

Each stage of the gate driving unit may include a first phase (sampling phase), a second phase (P output phase), a third phase (N output phase), and a fourth phase (holding phase).

During the first phase, the cascade driving unit 30 may control the first control unit 11 to be turned off, the first sub-control unit 121 of the second control unit 12 to be turned on, and the second sub-control unit 122 of the second control unit 12 to be turned off, so that the first output unit 10 may output a high-potential signal via the first sub-control unit 121. The cascade driving unit 30 may control the third control unit 21 to be turned on and the fourth control unit 22 to be turned off, so that the second output unit 20 may output a low-potential signal via the third control unit 21.

During the second phase, the cascade driving unit 30 may control the first control unit 11 to be turned on and the second control unit 12 to be turned off, so that the first output unit 10 may output a low-potential signal via the first control unit 11. The cascade driving unit 30 may control the third control unit 21 to be turned on and the fourth control unit 22 to be turned off, so that the second output unit 20 may output a low-potential signal via the third control unit 21.

During the third phase, the cascade driving unit 30 may control the first control unit 11 to be turned off, the second sub-control unit 122 of the second control unit 12 to be turned on, and the first sub-control unit 121 of the second control unit 12 to be turned off, so that the first output unit 10 may output a high-potential signal via the second sub-control unit 122. The cascade driving unit 30 may control the third control unit 21 to be turned off and the fourth control unit 22 to be turned on, so that the second output unit 20 may output a high-potential signal via the fourth control unit 22.

During the fourth phase, the cascade driving unit 30 may control the first control unit 11 to be turned off, the first sub-control unit 121 of the second control unit 12 to be turned on, and the second sub-control unit 122 of the second control unit 12 to be turned off, so that the first output unit 10 may output a high-potential signal via the first sub-control unit 121. The cascade driving unit 30 may control the third control unit 21 to be turned on and the fourth control unit 22 to be turned off, so that the second output unit 20 may output a low-potential signal via the third control unit 21.

As shown in FIG. 5, FIG. 5 is a schematic structural view of a gate driving unit according to a third embodiment of the present disclosure. As shown in FIG. 5, in some embodiments, the cascade driving unit 30 may include a first cascade unit 311, a first storage unit C1, a first storage output unit 312, a second storage unit C2, and a second storage output unit 321.

In the embodiments, an input terminal of the first cascade unit 311 may be connected to a first pulse signal Pscan(n-1) output by the previous-stage gate driving unit. An output terminal of the first cascade unit 311 may be connected to a first plate of the first storage unit C1. Since the previous-stage first pulse signal Pscan(n-1) is a pulse signal including a high potential and a low potential, the first storage unit C1 may store a high-potential signal and a low-potential signal.

The first storage unit C1 may include a first storage capacitor. The first plate of the first storage unit C1 may be connected to the first cascade unit 311, and the first storage unit C1 may be configured to store a high-potential signal and a low-potential signal. A second plate of the first storage unit C1 may be connected to a fixed signal line, such as ground. In other embodiments, the second plate of the first storage unit C1 may also be connected to other fixed signal lines, such as a high-potential signal line or a low-potential signal line, which is not limited herein.

The first storage output unit 312 may be connected to the first plate of the first storage unit C1, and configured to control the turn-on or turn-off of the first control unit 11 and the first sub-control unit 121 based on a potential signal stored in the first storage unit C1. The first storage output unit 312 may be disposed between the first plate of the first storage unit C1 and control terminals of the first control unit 11 and the first sub-control unit 121, and configured to transmit the potential signal (including a high-potential signal and a low-potential signal) stored in the first storage unit C1 to the control terminals of the first control unit 11 and the first sub-control unit 121, so as to control the turn-on or turn-off of the first control unit 11 and the first sub-control unit 121, thereby controlling whether the first pulse signal Pscan(n) is a high potential or a low potential.

The second storage unit C2 may include a second storage capacitor. A first plate of the second storage unit C2 may be configured to store a high-potential signal and a low-potential signal. In some embodiments, the first plate of the second storage unit C2 may be respectively connected to a pull-down unit 322 and a pull-up unit 323. The pull-down unit 322 and the pull-up unit 323 may not operate simultaneously to charge a high-potential signal and a low-potential signal into the first plate of the second storage unit C2 during different phases. A second plate of the second storage unit C2 may be grounded. In other embodiments, the second plate of the second storage unit C2 may also be connected to other fixed signal lines, such as a high-potential signal line or a low-potential signal line, which is not limited herein.

The second storage output unit 321 may be connected to the first plate of the second storage unit C2, and configured to control the turn-on or turn-off of the first sub-control unit 121, the second sub-control unit 122, the third control unit 21, and the fourth control unit 22 based on a potential signal stored in the second storage unit C2. The second storage output unit 321 may be disposed between the first plate of the second storage unit C2 and control terminals of the first sub-control unit 121, the second sub-control unit 122, the third control unit 21, and the fourth control unit 22, and may be configured to transmit the potential signal (including a high-potential signal and a low-potential signal) stored in the second storage unit C2 to the control terminals of the first sub-control unit 121, the second sub-control unit 122, the third control unit 21, and the fourth control unit 22, so as to control the turn-on or turn-off of the first sub-control unit 121, the second sub-control unit 122, the third control unit 21, and the fourth control unit 22, thereby controlling whether the first pulse signal Pscan(n) and the second pulse signal Nscan(n) output are high potentials or low potentials. The first sub-control unit 121, the second sub-control unit 122, the third control unit 21, and the fourth control unit 22 may include N-type transistors and P-type transistors with opposite driving characteristics, so that the first sub-control unit 121, the second sub-control unit 122, the third control unit 21, and the fourth control unit 22 may not be turned on simultaneously.

In some embodiments, an end of the pull-down unit 322 may be connected to the low-potential power line VGL, and another end of the pull-down unit 322 may be connected to the first plate of the second storage unit C2. The pull-down unit 322 may be configured to charge a low-potential signal into the first plate of the second storage unit C2 during the second phase. An end of the pull-up unit 323 may be connected to the high-potential power line VGH, and another end of the pull-up unit 323 may be connected to the first plate of the second storage unit C2. The pull-up unit 323 may be configured to charge a high-potential signal into the first plate of the second storage unit C2 during the fourth phase. In other embodiments, the pull-down unit 322 may include a low-potential power line VGL, and the pull-up unit 323 may include a high-potential power line VGH.

In some embodiments, control terminals of the pull-down unit 322 and the pull-up unit 323 may be connected to an output terminal of the first storage output unit 312. The pull-down unit 322 and the pull-up unit 323 may include a set of transistors with opposite driving polarities. That is, in a case where a transistor of the pull-down unit 322 is turned on, a transistor of the pull-up unit 323 may be cut off (turned off), so that a low-potential signal may be stored in the first plate of the second storage unit C2 via the pull-down unit 322. In a case where the transistor of the pull-down unit 322 is cut off, the transistor of the pull-up unit 323 may be turned on, so that a high-potential signal may be stored in the first plate of the second storage unit C2 via the pull-up unit 323. In other embodiments, the control terminals of the pull-down unit 322 and the pull-up unit 323 may also be respectively controlled by a set of driving signal lines with opposite polarities, which is not limited herein.

In some embodiments, the cascade driving unit 30 may further include a first sub-pull-up unit 31 and a second sub-pull-up unit 32. The first sub-pull-up unit 31 may be connected to the output terminal of the first storage output unit 312, and configured to pull up a low potential output by the first storage output unit 312. The second sub-pull-up unit 32 may be connected to an output terminal of the second storage output unit 321, and configured to pull up a low potential output by the second storage output unit 321.

In the third embodiment, the first sub-pull-up unit 31 may be connected to the control terminals of the first control unit 11 and the first sub-control unit 121, and configured to control the turn-on or turn-off of the first control unit 11 and the first sub-control unit 121 in a case where the first storage output unit 312 does not operate (i.e., is turned off). The second sub-pull-up unit 32 may be connected to the control terminals of the first sub-control unit 121, the second sub-control unit 122, the third control unit 21, and the fourth control unit 22, and configured to control the turn-on or turn-off of the first sub-control unit 121, the second sub-control unit 122, the third control unit 21, and the fourth control unit 22 in a case where the second storage output unit 321 does not operate (i.e., is turned off).

In some embodiments, the first sub-pull-up unit 31 may include a first resistor R1 and a high-potential signal line VGH1. The second sub-pull-up unit 32 may include a second resistor R2 and a high-potential signal line VGH1. The high-potential signal line VGH1 may be the high-potential power line VGH. It should be noted that both the first resistor R1 and the second resistor R2 may be large resistors with a resistance value ranging from 4.7 KΩ to 10 KΩ. Thus, in a case where the first storage output unit 312 outputs a low-potential signal to the control terminals of the first control unit 11 and the first sub-control unit 121, the control terminals of the first control unit 11 and the first sub-control unit 121 may be less affected by a high-potential signal transmitted on the high-potential signal line VGH1, and the first control unit 11 and the first sub-control unit 121 may be preferentially controlled by the discharge of the first storage unit C1. Similarly, the first sub-control unit 121, the second sub-control unit 122, the third control unit 21, and the fourth control unit 22 may be preferentially controlled by the discharge of the second storage unit C2. Control times of the low-potential signals stored in the first storage unit C1 and the second storage unit C2 on each control unit may be affected by discharge times of the first storage unit C1 and the second storage unit C2. The discharge times may be related to capacitance values of the first storage unit C1 and the second storage unit C2 and the resistance values of the first resistor R1 and the second resistor R2.

Driving phases of the gate driving unit in the third embodiment may include a first phase, a second phase, a third phase, and a fourth phase.

During the first phase, the first cascade unit 311 may charge a low-potential signal of the previous-stage first pulse signal Pscan(n-1) into the first storage unit C1. The second storage unit C2 may store a high-potential signal via the pull-up unit 323 in a previous phase, or the second storage unit C2 may store a high-potential signal via the pull-up unit 323 in this phase. In short, the first plate of the second storage unit C2 may store a high-potential signal. During the first phase, the high-potential signal stored in the second storage unit C2 may be transmitted to the control terminals of the first sub-control unit 121, the second sub-control unit 122, the third control unit 21, and the fourth control unit 22 via the second storage output unit 321, controlling the third control unit 21 and the first sub-control unit 121 to be turned on, and controlling the second sub-control unit 122 and the fourth control unit 22 to be turned off. During the first phase, the first control unit 11 may be controlled to be turned off and the first sub-control unit 121 to be turned on through the high-potential signal line VGH1. The high-potential signal line VGH1 may refer to a high-potential power line or other signal lines. The first control unit 11 may include a P-type transistor that is turned on at a low potential.

During the second phase, the low-potential signal stored in the first storage unit C1 during the first phase may be transmitted to the control terminals of the first control unit 11 and the first sub-control unit 121 via the first storage output unit 312, controlling the first control unit 11 to be turned on and the first sub-control unit 121 to be turned off, so that the first pulse signal Pscan(n) output by the N-th stage gate driving unit may be a low-potential signal. The control terminals of the third control unit 21, the second sub-control unit 122, and the fourth control unit 22 may also be connected to the high-potential signal line VGH1, so that the third control unit 21 may be controlled to remain turned on, and the second sub-control unit 122 and the fourth control unit 22 may be controlled to remain cut off. In this way, the second pulse signal Nscan(n) output may remain a low-potential signal. During the second phase, the low-potential signal stored in the first storage unit C1 may also be transmitted to a control terminal of the pull-down unit 322 via the first storage output unit 312, controlling the pull-down unit 322 to be turned on and operate. Meanwhile, the second storage output unit 321 may be turned off, so that the pull-down unit 322 may charge a low-potential signal into the first plate of the second storage unit C2.

During the third phase, the low-potential signal stored in the second storage unit C2 during the second phase may be output to the control terminals of the first sub-control unit 121, the second sub-control unit 122, the third control unit 21, and the fourth control unit 22 via the second storage output unit 321, controlling the second sub-control unit 122 and the fourth control unit 22 to be turned on, and the first sub-control unit 121 and the third control unit 21 to be cut off. Meanwhile, the first control unit 11 may be controlled to be cut off through the high-potential signal line VGH1. Thus, the output first pulse signal Pscan(n) may be a high-potential signal, and the output second pulse signal Nscan(n) may be a high-potential signal. During the third phase, the first cascade unit 311 may be turned on and the first storage output unit 312 may be turned off, so that the first cascade unit 311 may store the high-potential signal of the previous-stage first pulse signal Pscan(n-1) to the first plate of the first storage unit C1.

During the fourth phase, the high-potential signal stored in the first storage unit C1 during the third phase may be transmitted to the first control unit 11 and the first sub-control unit 121 via the first storage output unit 312, controlling the first control unit 11 to be cut off and the first sub-control unit 121 to be turned on. The high-potential power line VGH may output to the first pulse signal Pscan(n) via the first sub-control unit 121, so that the output first pulse signal Pscan(n) may be a high-potential signal. Meanwhile, the second sub-control unit 122, the third control unit 21, and the fourth control unit 22 may be controlled by a high-potential signal line, so that the third control unit 21 may be controlled to be turned on, and the second sub-control unit 122 and the fourth control unit 22 may be controlled to be cut off. In this way, the output second pulse signal Nscan(n) may be a low-potential signal.

During a subsequent phase of the fourth phase, the first control unit 11 and the first sub-control unit 121 may be controlled by the first storage output unit 312 or the high-potential signal line VGH1, so that the first control unit 11 may remain cut off and the first sub-control unit 121 may remain turned on, enabling the first pulse signal Pscan(n) to remain a high-potential signal output. The first sub-control unit 121, the second sub-control unit 122, the third control unit 21, and the fourth control unit 22 may be controlled by the second storage output unit 321 or the high-potential signal line VGH1, so that the first sub-control unit 121 and the third control unit 21 may remain turned on, and the second sub-control unit 122, the third control unit 21, and the fourth control unit 22 may remain cut off, enabling the second pulse signal Nscan(n) to remain a low-potential signal output. In the embodiments, the first sub-control unit 121 may include two transistors, which are respectively controlled by the first storage output unit 312 and the second storage output unit 321. The first sub-control unit 121 may be turned on only in a case where both two transistors are turned on. That is, only in a case where both the first storage output unit 312 and the second storage output unit 321 output high-potential signals, the first sub-control unit 121 may be turned on. The first control unit 11 may include a P-type transistor. The first sub-control unit 121 may include an N-type transistor. The third control unit 21 may include an N-type transistor. The second sub-control unit 122 and the fourth control unit 22 may include P-type transistors respectively.

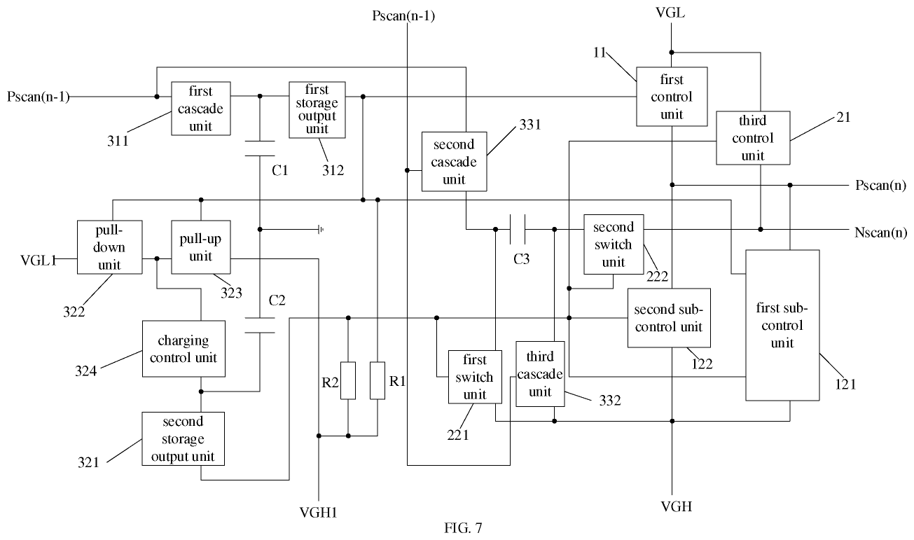

As shown in FIG. 6, FIG. 6 is a schematic structural view of a gate driving unit according to a fourth embodiment of the present disclosure. As shown in FIG. 6, the cascade driving unit 30 may include a first cascade unit 311, a first storage unit C1, a first storage output unit 312, a second storage unit C2, and a second storage output unit 321. The fourth embodiment may be a further embodiment of the first embodiment. The third embodiment may be a further embodiment of the second embodiment.

In the embodiments, an input terminal of the first cascade unit 311 may be connected to a first pulse signal Pscan(n-1) output by the previous-stage gate driving unit. An output terminal of the first cascade unit 311 may be connected to a first plate of the first storage unit C1.

The first storage unit C1 may include a first storage capacitor. The first plate of the first storage unit C1 may be connected to the first cascade unit 311, and the first storage unit C1 may be configured to store a high-potential signal and a low-potential signal transmitted by the previous-stage first pulse signal Pscan(n-1).

An end of the first storage output unit 312 may be connected to the first plate of the first storage unit C1. Another end of the first storage output unit 312 may be connected to the first control unit 11 and the second control unit 12. The first storage output unit 312 may be configured to control the turn-on or turn-off of the first control unit 11 and the second control unit 12 based on a potential signal stored in the first storage unit C1.

The second storage unit C2 may include a second storage capacitor. A first plate of the second storage unit C2 may be configured to store a high-potential signal and a low-potential signal. The first plate of the second storage unit C2 may be respectively connected to the pull-down unit 322 and the pull-up unit 323, and configured to store a high-potential signal and a low-potential signal during different phases.

An end of the second storage output unit 321 may be connected to the first plate of the second storage unit C2. Another end of the second storage output unit 321 may be connected to the third control unit 21 and the fourth control unit 22. The second storage output unit 321 may be configured to control the turn-on or turn-off of the third control unit 21 and the fourth control unit 22 based on a potential signal stored in the second storage unit C2.

Driving phases of the gate driving unit in the embodiments may include a first phase, a second phase, a third phase, and a fourth phase.

During the first phase, the first cascade unit 311 may charge a low-potential signal of the previous-stage first pulse signal Pscan(n-1) into the first storage unit C1. It should be noted that the low-potential signal of the previous-stage first pulse signal Pscan(n-1) may be a trigger signal/driving signal and configured to control the N-th stage gate driving unit to start working. The second storage unit C2 may store a high-potential signal. The second storage unit C2 may transmit the high-potential signal to the control terminals of the third control unit 21 and the fourth control unit 22 via the second storage output unit 321, controlling the third control unit 21 to be turned on and the fourth control unit 22 to be cut off, so that the output second pulse signal Nscan(n) may be a low-potential signal. In this phase, the control terminals of the first control unit 11 and the second control unit 12 may be connected to a high-potential signal line VGH1. The high-potential signal line VGH1 may control the first control unit 11 to be cut off and control the second control unit 12 to be turned on, so that the output first pulse signal Pscan(n) may be a high-potential signal.

During the second phase, the low-potential signal stored in the first storage unit C1 may be transmitted to the control terminals of the first control unit 11 and the second control unit 12 via the first storage output unit 312, controlling the first control unit 11 to be turned on and the second control unit 12 to be cut off, so that the output first pulse signal Pscan(n) may be a low-potential signal. Meanwhile, the control terminals of the third control unit 21 and the fourth control unit 22 may be connected to the high-potential signal line VGH1, controlling the third control unit 21 to be turned on and the fourth control unit 22 to be cut off, so that the output second pulse signal Nscan(n) may be a low-potential signal. In this phase, the pull-down unit 322 may be turned on and start to operate. A low-potential signal may be charged into the first plate of the second storage unit C2 via the pull-down unit 322.

During the third phase, the low-potential signal stored in the second storage unit C2 during the second phase may be output to the control terminals of the third control unit 21 and the fourth control unit 22 via the second storage output unit 321, thereby controlling the third control unit 21 to be cut off and the fourth control unit 22 to be turned on, so that the output second pulse signal Nscan(n) may be a high-potential signal. Meanwhile, the control terminals of the first control unit 11 and the second control unit 12 may be controlled by the high-potential signal line VGH1, controlling the first control unit 11 to be cut off and the second control unit 12 to be turned on, so that the output first pulse signal Pscan(n) may be a high-potential signal. During the third phase, the first cascade unit 311 may be turned on and the first storage output unit 312 may be turned off, so that the first cascade unit 311 may store the high-potential signal of the previous-stage first pulse signal Pscan(n-1) to the first plate of the first storage unit C1. After the third phase, the first plate of the first storage unit C1 may remain storing the high-potential signal.

During the fourth phase, the high-potential signal stored in the first storage unit C1 during the third phase may be transmitted to the first control unit 11 and the second control unit 12 via the first storage output unit 312, controlling the first control unit 11 to be cut off and the second control unit 12 to be turned on, so that the output first pulse signal Pscan(n) may be a high-potential signal. Meanwhile, the third control unit 21 and the fourth control unit 22 may be controlled by a high-potential signal line, controlling the third control unit 21 to be turned on and the fourth control unit 22 to be cut off, so that the output second pulse signal Nscan(n) may be a low-potential signal.

During a subsequent phase of the fourth phase, the first control unit 11 and the second control unit 12 may be controlled by the first storage output unit 312 (i.e., the high-potential signal stored in the first storage unit C1 during the third phase) or the high-potential signal line VGH1, so that the first control unit 11 may remain cut off and the second control unit 12 may remain turned on, enabling the first pulse signal Pscan(n) to remain a high-potential signal output. The third control unit 21 and the fourth control unit 22 may be controlled by the second storage output unit 321 (i.e., the high-potential signal stored in the second storage unit C2 during the fourth phase) or the high-potential signal line VGH1, so that the third control unit 21 may remain turned on and the fourth control unit 22 may remain cut off, enabling the second pulse signal Nscan(n) to remain a low-potential signal output.

In some embodiments, the cascade driving unit 30 may further include a first sub-pull-up unit 31 and a second sub-pull-up unit 32. The first sub-pull-up unit 31 may be connected to the control terminals of the first control unit 11 and the second control unit 12, and configured to control the turn-on or turn-off of the first control unit 11 and the second control unit 12 in a case where the first storage output unit 312 does not operate. The first sub-pull-up unit 31 may control the first control unit 11 to be cut off and the second control unit 12 to be turned on during the first phase. The first sub-pull-up unit 31 may pull up a low-potential signal output by the first storage output unit 312 during the second phase, thereby controlling the control time of the first storage output unit 312 on the first control unit 11 and the second control unit 12. The first sub-pull-up unit 31 may control the first control unit 11 to be cut off and the second control unit 12 to be turned on during the third phase. The second sub-pull-up unit 32 may be connected to the control terminals of the third control unit 21 and the fourth control unit 22, and configured to control the turn-on or turn-off of the third control unit 21 and the fourth control unit 22 in a case where the second storage output unit 321 does not operate. The second sub-pull-up unit 32 may control the third control unit 21 to be turned on and the fourth control unit 22 to be cut off during the second phase. The second sub-pull-up unit 32 may slowly pull up a low-potential signal output by the second storage output unit 321 during the third phase, thereby controlling the control time of the second storage output unit 321 on the third control unit 21 and the fourth control unit 22.

In the above embodiments, each of the first sub-pull-up unit 31 and the second sub-pull-up unit 32 may include a resistor and a high-potential signal line VGH1. A first resistor R1 may be disposed between the high-potential signal line VGH1 and the control terminals of the first control unit 11 and the second control unit 12. A second resistor R2 may be disposed between the high-potential signal line VGH1 and the control terminals of the third control unit 21 and the fourth control unit 22. Both the first resistor R1 and the second resistor R2 may be large resistors with a resistance value ranging from 4.7 KΩ to 10 KΩ. In a case where the first storage output unit 312 outputs a low-potential signal to the control terminals of the first control unit 11 and the second control unit 12, the control terminals of the first control unit 11 and the second control unit 12 may be less affected by a high-potential signal transmitted on the high-potential signal line VGH1, and the first control unit 11 and the second control unit 12 may be preferentially controlled by the discharge of the first storage unit C1. Similarly, the third control unit 21 and the fourth control unit 22 may be preferentially controlled by the discharge of the second storage unit C2. In other embodiments, the first sub-pull-up unit 31 and the second sub-pull-up unit 32 may also include other circuit devices, such as normally-on transistors, which is not limited herein.

It should be noted that output phases of the first pulse signal Pscan(n) and the second pulse signal Nscan(n) may depend on discharge times of the first storage unit C1 and the second storage unit C2. The high-potential signal line VGH1 may have a neutralizing effect on the discharge of the low-potential signals stored in the first storage unit C1 and the second storage unit C2. A neutralization time may be related to capacitance values of the first storage unit C1 and the second storage unit C2 and the resistance values of the first resistor R1 and the second resistor R2.

In some embodiments, control terminals of the first cascade unit 311 and the first storage output unit 312 may be controlled by a set of driving signal lines with opposite pulse phases. A first driving signal line XCK and a second driving signal line CK may be provided. The first driving signal line XCK and the second driving signal line CK may provide pulse voltages with the same frequency and opposite pulse phases. In a case where the first driving signal line XCK provides a high-potential signal, the second driving signal CK may provide a low-potential signal. In a case where the first driving signal line XCK provides a low-potential signal, the second driving signal CK may provide a high-potential signal. In other embodiments, the control terminals of the first cascade unit 311 and the first storage output unit 312 may be controlled by the same driving signal line. The first cascade unit 311 and the first storage output unit 312 may respectively include an N-type transistor and a P-type transistor with different conduction conditions, which is not limited herein.

In some embodiments, control terminals of the second storage output unit 321 and the first storage output unit 312 may be controlled by a set of driving signal lines with the same pulse frequency and opposite pulse phases. That is, the second storage output unit 321 and the first storage output unit 312 may not be turned on simultaneously. The set of driving signal lines may be the first driving signal line XCK and the second driving signal line CK.

In some embodiments, control terminals of the pull-down unit 322 and the pull-up unit 323 may be controlled by the same control signal line, and the pull-down unit 322 and the pull-up unit 323 may respectively include an N-type transistor and a P-type transistor with opposite driving characteristics. The control terminals of the pull-down unit 322 and the pull-up unit 323 may be connected to the output terminal of the first storage output unit 312, thereby controlling the pull-down unit 322 to be turned on or the pull-up unit 323 to be turned on based on the high-potential signal and low-potential signal stored in the first storage unit C1.

In some embodiments, the cascade driving unit 30 may further include a charging control unit 324. The charging control unit 324 may be disposed between the output terminals of the pull-up unit 323 and the pull-down unit 322 and the first plate of the second storage unit C2, and connected to the output terminals of the pull-up unit 323 and the pull-down unit 322 and the first plate of the second storage unit C2. The charging control unit 324 may be configured to control the pull-up unit 323 or the pull-down unit 322 to store a high-potential signal or a low-potential signal into the first plate of the second storage unit C2. The charging control unit 324 may be turned on during the second phase and the fourth phase, enabling the pull-down unit 322 to charge a low-potential signal into the first plate of the second storage unit C2 during the second phase, and enabling the pull-up unit 323 to charge a high-potential signal into the first plate of the second storage unit C2 during the fourth phase.

It should be noted that in other embodiments, the pull-up unit 323 and the pull-down unit 322 may be controlled by other control lines to realize charging the second storage unit C2 during the second phase and the fourth phase respectively, which is not limited by the embodiments.

In some embodiments, control terminals of the charging control unit 324 and the second storage output unit 321 may be controlled by a set of driving signal lines with opposite pulse phases, for example, the first driving signal line XCK and the second driving signal line CK. The charging control unit 324 and the second storage output unit 321 may not be turned on simultaneously. The charging control unit 324 may be turned on during the second phase and the fourth phase to charge the second storage unit C2. The second storage output unit 321 may be turned on during the first phase and the third phase to control the discharge of the second storage unit C2.

As shown in FIG. 7, FIG. 7 is a schematic structural view of a gate driving unit according to a fifth embodiment of the present disclosure. As shown in FIG. 7, the fourth control unit 22 may further include a third storage unit C3. A first plate of the third storage unit C3 may be connected to the cascade driving unit 30. A second plate of the third storage unit C3 may be connected to the high-potential power line VGH and configured to store an initial voltage signal. By changing a voltage on the first plate of the third storage unit C3, a voltage output by the second plate of the third storage unit C3 may be controlled.

In some embodiments, the cascade driving unit 30 may further include a second cascade unit 331 and a third cascade unit 332. The second cascade unit 331 may be connected to the first plate of the third storage unit C3 and configured to charge an initial voltage signal into the first plate of the third storage unit C3. The third cascade unit 332 may be connected to the second plate of the third storage unit C3 and configured to charge an initial voltage signal into the second plate of the third storage unit C3.

The second cascade unit 331 may be disposed between the first output unit 10 of the previous-stage gate driving unit GOA(n-1) and the first plate of the third storage unit C3, and configured to control charging an initial voltage signal into the first plate of the third storage unit C3. In some embodiments, the second cascade unit 331 may be controlled to charge the low-potential signal of the previous-stage first pulse signal Pscan(n-1) into the first plate of the third storage unit C3 during the first phase. The third cascade unit 332 may be disposed between the high-potential power line VGH and the second plate of the third storage unit C3, and configured to control charging an initial voltage signal into the second plate of the third storage unit C3. The second cascade unit 331 and the third cascade unit 332 may respectively charge different voltage signals into the first plate and the second plate of the third storage unit C3, so that the third storage unit C3 may store an initial voltage difference. It can be understood that the second cascade unit 331 and the third cascade unit 332 may be respectively connected to other signal lines or other circuit designs, so that the first plate and the second plate of the third storage unit C3 may be charged with different voltage signals, which is not limited herein.

In some embodiments, control terminals of the second cascade unit 331 and the third cascade unit 332 may both be connected to the first pulse signal Pscan(n-1) output by the first output unit 10 of the previous-stage gate driving unit GOA(n-1). That is, the second cascade unit 331 and the third cascade unit 332 may be controlled by the same low-potential pulse signal line with a normal high potential, and may be turned on during a low-potential pulse phase and turned off during other phases, thereby controlling the storage of an initial voltage into the third storage unit C3. The second cascade unit 331 and the third cascade unit 332 may be controlled to write a voltage into the third storage unit C3 during the first phase.

In some embodiments, the fourth control unit 22 may further include a first switch unit 221 and a second switch unit 222. The first switch unit 221 may be connected between the first plate of the third storage unit C3 and the high-potential power line VGH, and may be configured to pull up the initial voltage signal stored in the third storage unit C3. During a high-potential output stage, the first switch unit 221 may be configured to pull up a voltage on the first plate of the third storage unit C3, enabling a voltage on the second plate of the third storage unit C3 to be pulled up accordingly, thereby realizing high-potential output. The second switch unit 222 may be connected between the second plate of the third storage unit C3 and an output terminal of the second pulse signal Nscan(n), and may be configured to control the output of the second pulse signal Nscan(n), i.e., the high-potential output of the second pulse signal Nscan(n), based on a voltage signal stored in the third storage unit C3. Control terminals of the first switch unit 221 and the second switch unit 222 may be controlled by the same control signal line. In some embodiments, the control terminals of the first switch unit 221 and the second switch unit 222 may be connected to the output terminal of the second storage output unit 321. In the embodiments, the first switch unit 221 and the second switch unit 222 may be turned on during the third phase, thereby controlling the second pulse signal Nscan(n) to be output as a high-potential signal.

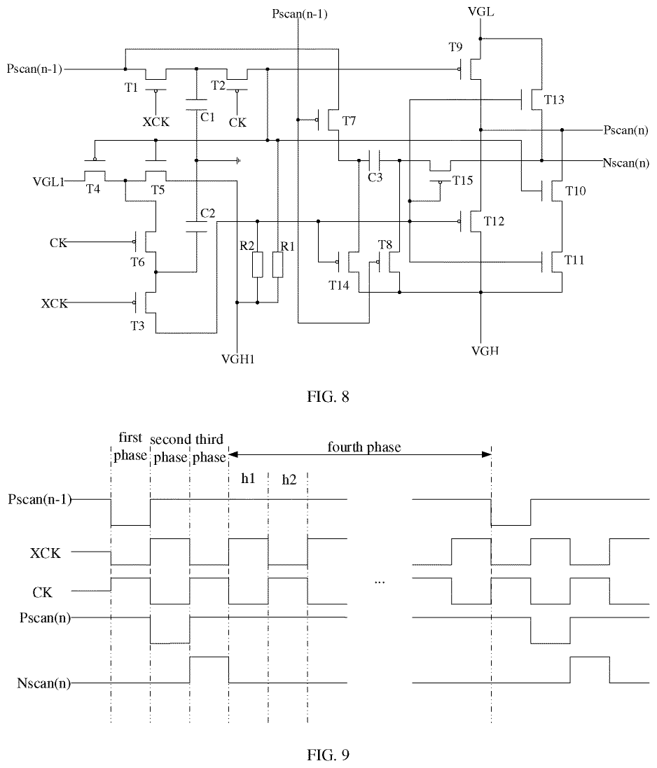

As shown in FIG. 8, FIG. 8 is a schematic circuit structural view of a gate driving unit according to a sixth embodiment of the present disclosure.

The first cascade unit 311 may include a first transistor T1. The first storage output unit 312 may include a second transistor T2. The second storage output unit 321 may include a third transistor T3. The pull-down unit 322 may include a low-potential signal line VGL1 and a fourth transistor T4. The pull-up unit 323 may include a high-potential signal line VGH1 and a fifth transistor T5. The charging control unit 324 may include a sixth transistor T6. The second cascade unit 331 may include a seventh transistor T7. The third cascade unit 332 may include an eighth transistor T8.

The first control unit 11 may include a ninth transistor T9. The first sub-control unit 121 may include a tenth transistor T10 and an eleventh transistor T11. The second sub-control unit 122 may include a twelfth transistor T12. The third control unit 21 may include a thirteenth transistor T13. The fourth control unit 22 may include a fourteenth transistor T14, a fifteenth transistor T15, and a third storage unit (third capacitor) C3.

The first sub-pull-up unit 31 may include a first resistor R1 and a high-potential signal line VGH1. The second sub-pull-up unit 32 may include a second resistor R2 and a high-potential signal line VGH1. The high-potential signal line VGH1 may be the high-potential power line VGH. The low-potential signal line VGL1 may be the low-potential power line VGL.

In the embodiments, the tenth transistor T10, the eleventh transistor T11, and the thirteenth transistor T13 may be N-type transistors. Other transistors may be P-type transistors.

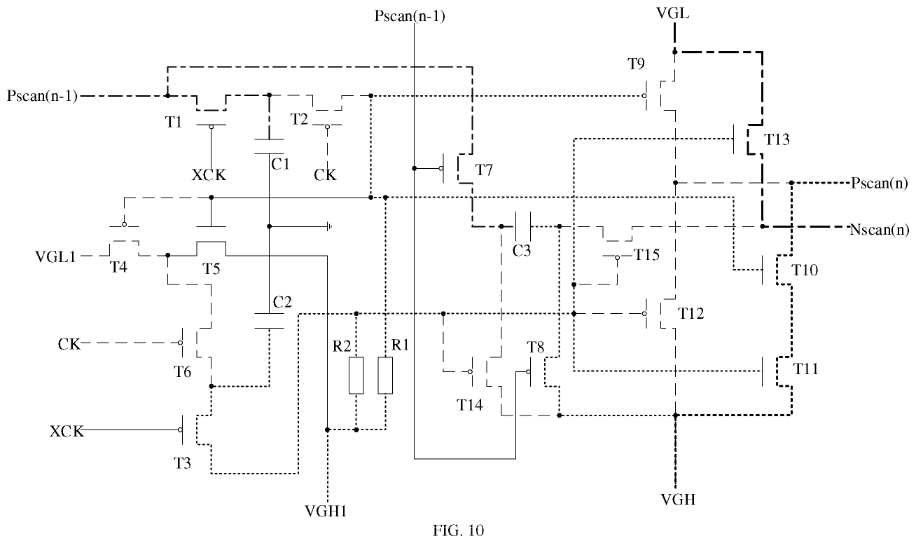

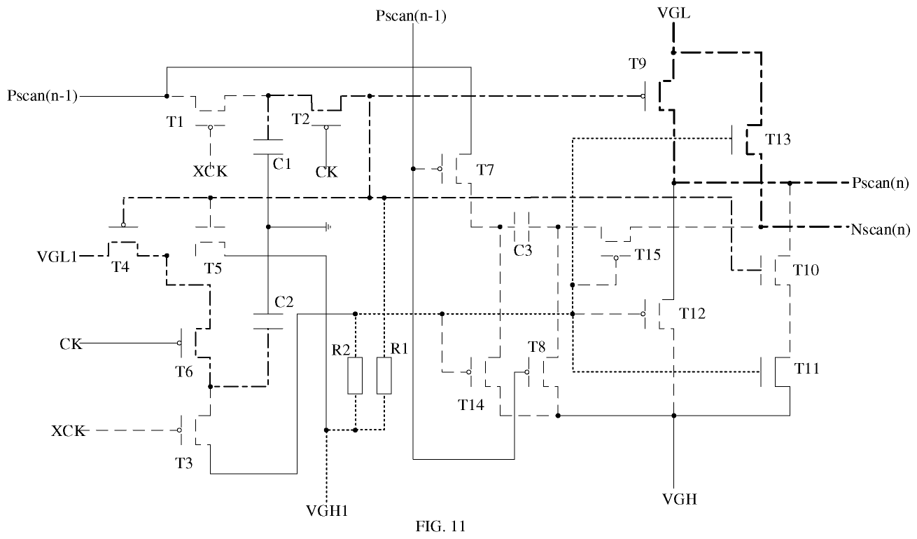

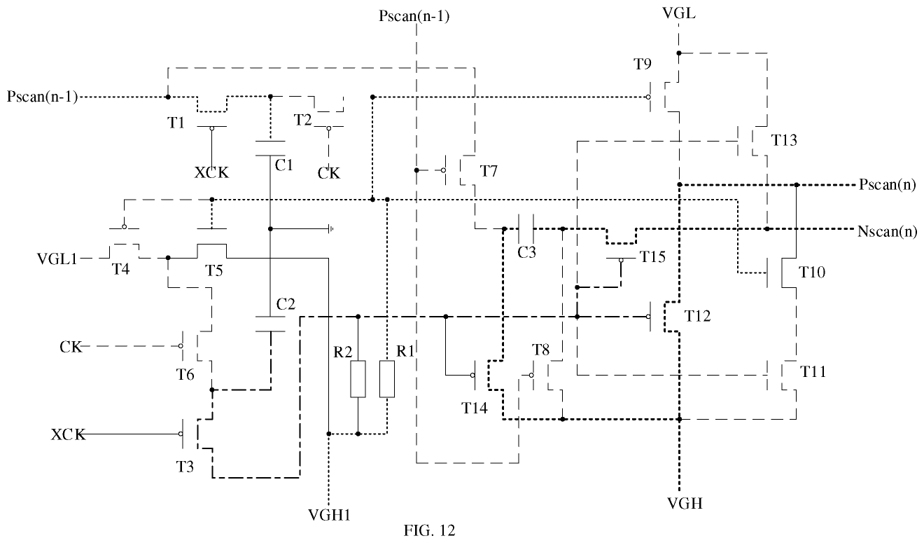

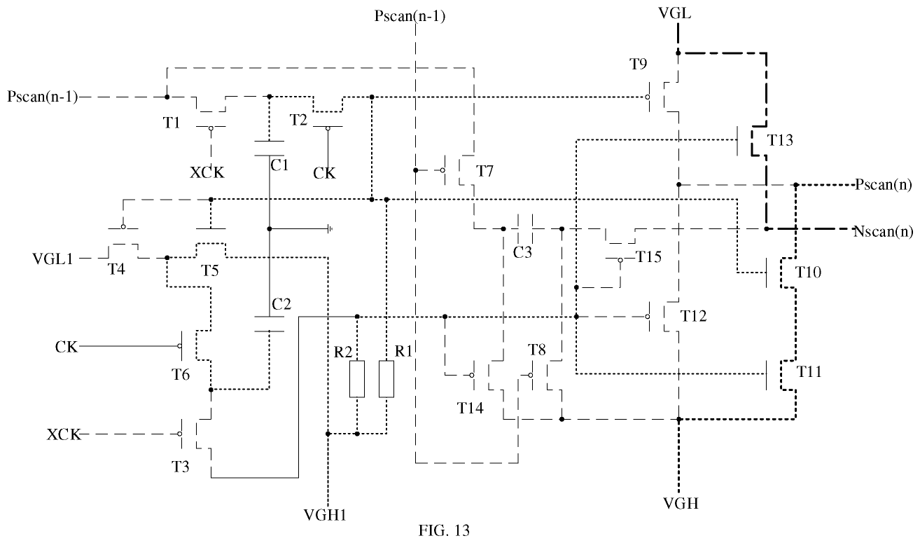

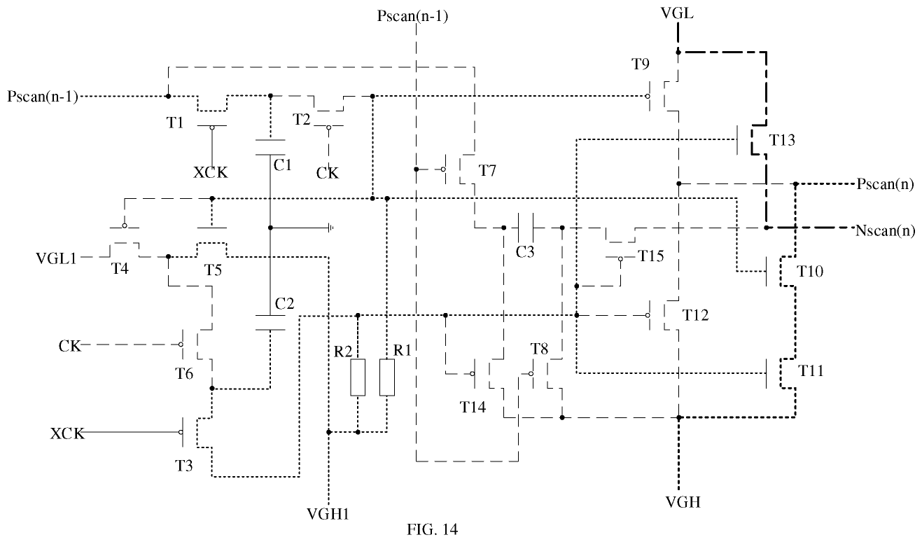

The present disclosure may also provide a driving timing view of the gate driving unit according to the sixth embodiment. As shown in FIG. 9, FIG. 9 is a driving timing view of the gate driving unit according to the sixth embodiment of the present disclosure. Driving phases may include a first phase, a second phase, a third phase, and a fourth phase. As shown in FIG. 10 to FIG. 14, FIG. 10 is a circuit view of a first driving phase of the gate driving unit according to the sixth embodiment of the present disclosure, FIG. 11 is a circuit view of a second driving phase of the gate driving unit according to the sixth embodiment of the present disclosure, FIG. 12 is a circuit view of a third driving phase of the gate driving unit according to the sixth embodiment of the present disclosure, FIG. 13 is a circuit view of a fourth driving phase of the gate driving unit according to the sixth embodiment of the present disclosure, FIG. 14 is a circuit view of a fifth driving phase of the gate driving unit according to the sixth embodiment of the present disclosure.

The first phase may also refer to a sampling phase. During the first phase, the previous-stage first pulse signal Pscan(n-1) may be a low-potential signal. Meanwhile, the first driving signal line XCK may transmit a low-potential signal and the second driving signal line CK may transmit a high-potential signal. The first driving signal line XCK and the second driving signal line CK may control the first transistor T1 to be turned on and the second transistor T2 to be cut off. The previous-stage first pulse signal Pscan(n-1) may store a low-potential signal on the first plate of the first storage unit C1. The previous-stage first pulse signal Pscan(n-1) may control the seventh transistor T7 and the eighth transistor T8 to be turned on. The previous-stage first pulse signal Pscan(n-1) may charge a low-potential signal into the first plate of the third storage unit C3 via the seventh transistor T7. The high-potential power line VGH may charge a high-potential signal into the second plate of the third storage unit C3 via the eighth transistor T8. The initial voltage difference stored in the third storage unit C3 may be VGH−Vpscan(n-1). At this phase, the first driving signal line XCK may control the third transistor T3 to be turned on. Since the second storage unit C2 may store a high-potential signal in the previous phase and the high-potential signal line VGH1 may provide a high-potential signal to an output terminal of the second storage unit C2 via the second resistor R2 (i.e., the second sub-pull-up unit), the second storage unit C2 may discharge and output a high-potential signal, controlling the thirteenth transistor T13 and the eleventh transistor T11 to be turned on, and controlling the twelfth transistor T12, the fourteenth transistor T14, and the fifteenth transistor T15 to be cut off. At this phase, the high-potential signal line VGH1 may also transmit a high-potential signal to the ninth transistor T9 and the tenth transistor T10 via the first resistor R1, controlling the ninth transistor T9 to be cut off and the tenth transistor T10 to be turned on. Thus, at this phase, the first pulse signal Pscan(n) may output a high-potential signal (VGH), and the second pulse signal Nscan(n) may output a low-potential signal (VGL). As shown in FIG. 10, solid lines may indicate signal transmission, first dashed lines (including multiple longer segments, i.e., long dashes) may indicate no signal transmission, second dashed lines (including multiple shorter segments, i.e., short dashes) may indicate high-potential signal transmission, and third dashed lines (including alternating long dashes and short dashes) may indicate low-potential signal transmission.

The second phase may also refer to a P output stage (i.e., a low-potential output stage). During the second phase, the previous-stage first pulse signal Pscan(n-1) may be a high-potential signal. Meanwhile, the first driving signal line XCK may transmit a high-potential signal and the second driving signal line CK may transmit a low-potential signal. The second driving signal line CK may control the second transistor T2 to be turned on. The low-potential signal stored in the first storage unit C1 during the first phase may be discharged via the second transistor T2. At this phase, the pull-up effect of the first sub-pull-up unit on an output terminal of the second transistor T2 may be less than the discharge of the first storage unit C1. The first storage unit C1 may transmit the low-potential signal to control terminals of the ninth transistor T9 and the tenth transistor T10 via the second transistor T2, controlling the ninth transistor T9 to be turned on and the tenth transistor T10 to be cut off. The first storage unit C1 may also transmit the low-potential signal to control terminals of the fourth transistor T4 and the fifth transistor T5 via the second transistor T2, controlling the fourth transistor T4 to be turned on and the fifth transistor T5 to be cut off. Meanwhile, the second driving signal line CK may control the sixth transistor T6 to be turned on. The low-potential signal line VGL1 may transmit a low-potential signal to the first plate of the second storage unit C2 via the fourth transistor T4 and the sixth transistor T6, and the first plate of the second storage unit C2 may store the low-potential signal. At this phase, the first driving signal line XCK may control the third transistor T3 to be cut off. The high-potential signal line VGH1 may remain transmitting a high-potential signal to control terminals of the eleventh transistor T11, the twelfth transistor T12, the thirteenth transistor T13, the fourteenth transistor T14, and the fifteenth transistor T15 via the second resistor R2, controlling the thirteenth transistor T13 and the eleventh transistor T11 to be turned on, and controlling the twelfth transistor T12, the fourteenth transistor T14, and the fifteenth transistor T15 to be cut off. At this phase, the low-potential power line VGL may output low-potential signals to the first output unit and the second output unit via the ninth transistor T9 and the thirteenth transistor T13 respectively. That is, the first pulse signal Pscan(n) may output a low-potential signal (VGL) and the second pulse signal Nscan(n) may output a low-potential signal (VGL). As shown in FIG. 11, solid lines may indicate signal transmission, first dashed lines (including multiple longer segments, i.e., long dashes) may indicate no signal transmission, second dashed lines (including multiple shorter segments, i.e., short dashes) may indicate high-potential signal transmission, and third dashed lines (including alternating long dashes and short dashes) may indicate low-potential signal transmission. At this phase, the third storage unit C3 may not operate and may maintain the initial voltage difference stored during the first phase.

The third phase may also refer to an N output stage (i.e., a high-potential output stage). During the third phase, the previous-stage first pulse signal Pscan(n-1) may be a high-potential signal. Meanwhile, the first driving signal line XCK may transmit a low-potential signal and the second driving signal line CK may transmit a high-potential signal. The first driving signal line XCK may control the first transistor T1 to be turned on. The previous-stage first pulse signal Pscan(n-1) may store a high-potential signal on the first plate of the first storage unit C1. That is, the first storage unit C1 may restore a high-potential signal. The first driving signal line XCK may control the third transistor T3 to be turned on. The low-potential signal stored in the second storage unit C2 during the second phase may be transmitted to control terminals of the eleventh transistor T11, the twelfth transistor T12, the thirteenth transistor T13, the fourteenth transistor T14, and the fifteenth transistor T15 via the third transistor T3, controlling the thirteenth transistor T13 and the eleventh transistor T11 to be turned off, and controlling the twelfth transistor T12, the fourteenth transistor T14, and the fifteenth transistor T15 to be turned on. Thus, the high-potential power line VGH may charge a high-potential signal into the first plate of the third storage unit C3 via the fourteenth transistor T14. According to Kirchhoff's Voltage Law (KVL), a voltage on the second plate of the third storage unit C3 may be coupled to VGH−Vpscan(n-1)+VGH=2VGH−Vpscan(n-1), which may be a high-potential signal. The high-potential signal on the second plate of the third storage unit C3 may be transmitted to the output terminal of the second pulse signal Nscan(n) via the fifteenth transistor T15, so that the output second pulse signal Nscan(n) may be a high-potential signal. Meanwhile, the high-potential power line VGH may transmit a high-potential signal to the output terminal of the first pulse signal Pscan(n) via the twelfth transistor T12, so that the output first pulse signal Pscan(n) may be a high-potential signal. At this phase, the high-potential signal line VGH1 may slowly pull up the low-potential signal output by the second storage unit C2 via the second resistor R2 until the second storage unit C2 is completely discharged, thereby controlling conduction times of the twelfth transistor T12, the fourteenth transistor T14, and the fifteenth transistor T15. At this phase, the second driving signal line CK may control the second transistor T2 to be turned off. The high-potential signal line VGH1 may provide a high-potential signal to the ninth transistor T9 and the tenth transistor T10 via the first resistor R1, enabling the ninth transistor T9 to be turned off and the tenth transistor T10 to be turned on. As shown in FIG. 12, solid lines may indicate signal transmission, first dashed lines (including multiple longer segments, i.e., long dashes) may indicate no signal transmission, second dashed lines (including multiple shorter segments, i.e., short dashes) may indicate high-potential signal transmission, and third dashed lines (including alternating long dashes and short dashes) may indicate low-potential signal transmission.

The fourth phase may also refer to a holding phase. The fourth phase may include a first holding phase h1 and a second holding phase h2. The first holding phase h1 and the second holding phase h2 may perform alternately.

During the first holding phase h1, the previous-stage first pulse signal Pscan(n-1) may be a high-potential signal. Meanwhile, the first driving signal line XCK may transmit a high-potential signal and the second driving signal line CK may transmit a low-potential signal. The high-potential signal stored in the first storage unit C1 during the third phase may be transmitted to control terminals of the ninth transistor T9 and the tenth transistor T10 via the second transistor T2, controlling the ninth transistor T9 to be turned off and the tenth transistor T10 to be turned on. Meanwhile, the high-potential signal line VGH1 may transmit a high-potential signal to the first plate of the second storage unit C2 via the fifth transistor T5 and the sixth transistor T6, and the first plate of the second storage unit C2 may store the high-potential signal. Meanwhile, the high-potential signal line VGH1 may transmit a high-potential signal to control terminals of the eleventh transistor T11, the twelfth transistor T12, the thirteenth transistor T13, the fourteenth transistor T14, and the fifteenth transistor T15 via the second resistor R2, controlling the thirteenth transistor T13 and the eleventh transistor T11 to be turned on, and controlling the twelfth transistor T12, the fourteenth transistor T14, and the fifteenth transistor T15 to be turned off. At this phase, the high-potential power line VGH may transmit a high-potential signal to the output terminal of the first pulse signal Pscan(n) (i.e., the first output unit) via the tenth transistor T10 and the eleventh transistor T11, so that the output first pulse signal Pscan(n) may be a high-potential signal. The low-potential power line VGL may transmit a low-potential signal to the output terminal of the second pulse signal Nscan(n) (i.e., the second output unit) via the thirteenth transistor T13, so that the output second pulse signal Nscan(n) may be a low-potential signal. As shown in FIG. 13, solid lines may indicate signal transmission, first dashed lines (including multiple longer segments, i.e., long dashes) may indicate no signal transmission, second dashed lines (including multiple shorter segments, i.e., short dashes) may indicate high-potential signal transmission, and third dashed lines (including alternating long dashes and short dashes) may indicate low-potential signal transmission.

During the second holding phase, the previous-stage first pulse signal Pscan(n-1) may be a high-potential signal. Meanwhile, the first driving signal line XCK may transmit a low-potential signal and the second driving signal line CK may transmit a high-potential signal. The previous-stage first pulse signal Pscan(n-1) may store a high-potential signal on the first plate of the first storage unit C1 via the first transistor T1. The first driving signal line XCK may control the third transistor T3 to be turned on. The high-potential signal stored in the second storage unit C2 during the first holding phase may be transmitted to control terminals of the eleventh transistor T11, the twelfth transistor T12, the thirteenth transistor T13, the fourteenth transistor T14, and the fifteenth transistor T15 via the third transistor T3, controlling the thirteenth transistor T13 and the eleventh transistor T11 to be turned on, and controlling the twelfth transistor T12, the fourteenth transistor T14, and the fifteenth transistor T15 to be turned off. Meanwhile, the high-potential signal line VGH1 may provide a high-potential signal to the ninth transistor T9 and the tenth transistor T10 via the first resistor R1, enabling the ninth transistor T9 to be turned off and the tenth transistor T10 to be turned on. At this phase, the high-potential power line VGH may transmit a high-potential signal to the output terminal of the first pulse signal Pscan(n) (i.e., the first output unit) via the tenth transistor T10 and the eleventh transistor T11, so that the output first pulse signal Pscan(n) may be a high-potential signal. The low-potential power line VGL may transmit a low-potential signal to the output terminal of the second pulse signal Nscan(n) (i.e., the second output unit) via the thirteenth transistor T13, so that the output second pulse signal Nscan(n) may be a low-potential signal. As shown in FIG. 14, solid lines may indicate signal transmission, first dashed lines (including multiple longer segments, i.e., long dashes) may indicate no signal transmission, second dashed lines (including multiple shorter segments, i.e., short dashes) may indicate high-potential signal transmission, and third dashed lines (including alternating long dashes and short dashes) may indicate low-potential signal transmission.

The fourth phase may include a plurality of first holding phases and a plurality of second holding phases performed alternately. During the fourth phase, regardless of signal transitions on the first driving signal line XCK and the second driving signal line CK, the outputs of the first pulse signal Pscan(n) and the second pulse signal Nscan(n) may remain unchanged. The first pulse signal Pscan(n) may maintain a high-potential signal output, and the second pulse signal Nscan(n) may maintain a low-potential signal output.

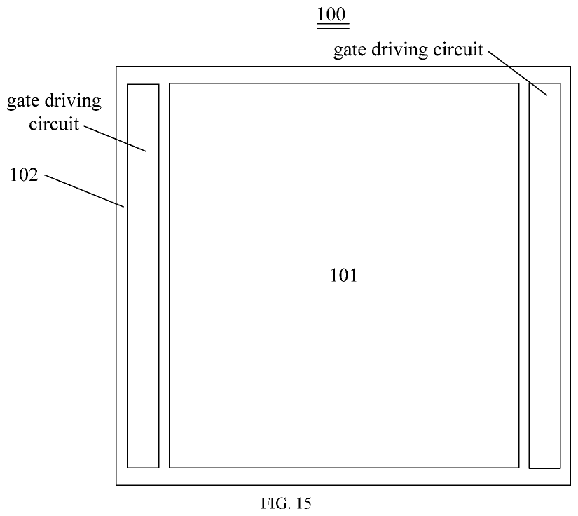

The present disclosure also provides a display panel. As shown in FIG. 15, FIG. 15 is a schematic structural view of a display panel according to some embodiment of the present disclosure. As shown in FIG. 15, the display panel 100 may include a display area 101 and a non-display area 102. The gate driving circuit according to any one of the above embodiments may be disposed in the non-display area 102 on one side or opposite sides of the display panel 100. The gate driving circuit may include the plurality of gate driving units connected in cascades. The gate driving circuit may sequentially transmit a first scanning signal and a second scanning signal to each row of pixel units in the display area 101. The first scanning signal may be the first pulse signal Pscan(n) which is a low-potential pulse with a normal high potential. The second scanning signal may be the second pulse signal Nscan(n) which is a high-potential pulse with a normal low potential.

In some embodiments, the driving circuit in each pixel unit of the display area 101 may include both an N-type transistor and a P-type transistor. By sequentially outputting the first scanning signal and the second scanning signal to the driving unit of the pixel unit, the requirement of outputting different scanning signals to different types of transistors (TFTs) in the pixel unit may be satisfied.

By designing the above gate driving circuit, the present disclosure may enable one GOA circuit to respectively output different scanning signals to different types of transistors (TFTs) in the pixel unit while minimizing the use of input terminal signals as much as possible, thereby saving circuit costs and reducing a border width.

The above are only embodiments of the present disclosure, and are not intended to limit the patent scope of the present disclosure. Any equivalent structure or equivalent process transformation made based on the content of the specification and drawings of the present disclosure, or directly or indirectly applied in other related technical fields, is similarly included in the patent protection scope of the present disclosure.

1. A gate driving circuit, comprising a plurality of gate driving units connected in cascades, wherein each of the gate driving units at least comprises:
a cascade driving unit, connected to a previous-stage gate driving unit;
a first output unit, connected to the cascade driving unit and configured to output a first pulse signal, wherein the first pulse signal is a low-potential pulse signal with a normal high potential;
a second output unit, connected to the cascade driving unit and configured to output a second pulse signal, wherein the second pulse signal is a high-potential pulse signal with a normal low potential.

2. The gate driving circuit according to claim 1, wherein the cascade driving unit is connected to a first output unit of the previous-stage gate driving unit.

3. The gate driving circuit according to claim 2, wherein
the first output unit comprises a first control unit and a second control unit; an input terminal of the first control unit is connected to a low-potential power line, an input terminal of the second control unit is connected to a high-potential power line, and control terminals of the first control unit and the second control unit are connected to the cascade driving unit; the cascade driving unit is configured to control the first control unit and the second control unit to be alternately turned on, controlling the first output unit to output the first pulse signal;
the second output unit comprises a third control unit and a fourth control unit; an input terminal of the third control unit is connected to the low-potential power line, an input terminal of the fourth control unit is connected to the high-potential power line, and control terminals of the third control unit and the fourth control unit are connected to the cascade driving unit; the cascade driving unit is configured to control the third control unit and the fourth control unit to be alternately turned on, controlling the second output unit to output the second pulse signal.

4. The gate driving circuit according to claim 3, wherein the second control unit comprises a first sub-control unit and a second sub-control unit, input terminals of the first sub-control unit and the second sub-control unit are both connected to the high-potential power line, and control terminals of the first sub-control unit and the second sub-control unit are both connected to the cascade driving unit, controlling the first output unit to output the first pulse signal.

5. The gate driving circuit according to claim 3, wherein the cascade driving unit comprises:
a first cascade unit, connected to the first output unit of the previous-stage gate driving unit;
a first storage unit, wherein a first plate of the first storage unit is connected to the first cascade unit and is configured to store a high-potential signal and a low-potential signal;
a first storage output unit, connected to the first plate of the first storage unit, and configured to control the turn-on or turn-off of the first control unit and the second control unit respectively based on a potential signal stored in the first storage unit;
a second storage unit, configured to store a high-potential signal and a low-potential signal;
a second storage output unit, connected to a first plate of the second storage unit, and configured to control the turn-on or turn-off of the third control unit and the fourth control unit respectively based on a potential signal stored in the second storage unit.

6. The gate driving circuit according to claim 4, wherein the cascade driving unit comprises:
a first cascade unit, connected to the first output unit of the previous-stage gate driving unit;
a first storage unit, wherein a first plate of the first storage unit is connected to the first cascade unit and is configured to store a high-potential signal and a low-potential signal;
a first storage output unit, connected to the first plate of the first storage unit and control terminals of the first control unit and the first sub-control unit, and configured to control the turn-on or turn-off of the first control unit and the first sub-control unit respectively based on a potential signal stored in the first storage unit;
a second storage unit, configured to store a high-potential signal and a low-potential signal;
a second storage output unit, connected to a first plate of the second storage unit and control terminals of the first sub-control unit, the second sub-control unit, the third control unit, and the fourth control unit, and configured to control the turn-on or turn-off of the first sub-control unit, the second sub-control unit, the third control unit, and the fourth control unit respectively based on a potential signal stored in the second storage unit.

7. The gate driving circuit according to claim 6, wherein the cascade driving unit further comprises:
a pull-down unit, connected to the first plate of the second storage unit and configured to store a low-potential signal into the second storage unit;
a pull-up unit, connected to the first plate of the second storage unit and configured to store a high-potential signal into the second storage unit;
wherein the pull-down unit and the pull-up unit do not operate simultaneously, and the pull-down unit and the pull-up unit comprise a set of transistors with opposite driving polarities.

8. The gate driving circuit according to claim 7, wherein control terminals of the first cascade unit and the first storage output unit are controlled by a set of driving signal lines with opposite pulse phases.

9. The gate driving circuit according to claim 7, wherein control terminals of the second storage output unit and the first storage output unit are controlled by a set of driving signal lines with opposite pulse phases.

10. The gate driving circuit according to claim 7, wherein the cascade driving unit further comprises a charging control unit;
the charging control unit is connected to the pull-up unit, the pull-down unit, and the first plate of the second storage unit, and is configured to control the pull-up unit and the pull-down unit respectively to store a high-potential signal or a low-potential signal into the first plate of the second storage unit.

11. The gate driving circuit according to claim 10, wherein control terminals of the charging control unit and the second storage output unit are controlled by a set of driving signal lines with opposite pulse phases.

12. The gate driving circuit according to claim 5, wherein the cascade driving unit further comprises:
a first sub-pull-up unit, connected to an output terminal of the first storage output unit, and configured to pull up a low potential output by the first storage output unit;
a second sub-pull-up unit, connected to an output terminal of the second storage output unit, and configured to pull up a low potential output by the second storage output unit.

13. The gate driving circuit according to claim 12, wherein the first sub-pull-up unit comprises a first resistor and a high-potential signal line, and the second sub-pull-up unit comprises a second resistor and a high-potential signal line.

14. The gate driving circuit according to claim 3, wherein the fourth control unit comprises a third storage unit, a first plate of the third storage unit is connected to the cascade driving unit, a second plate of the third storage unit is connected to the high-potential power line, and the third storage unit is configured to store an initial voltage signal.

15. The gate driving circuit according to claim 14, wherein the cascade driving unit comprises:
a second cascade unit, connected to the first plate of the third storage unit and the first output unit of the previous-stage gate driving unit, and configured to charge an initial voltage signal into the first plate of the third storage unit;
a third cascade unit, connected to the second plate of the third storage unit and the high-potential power line, and configured to charge an initial voltage signal into the second plate of the third storage unit;
wherein control terminals of the second cascade unit and the third cascade unit are both connected to the first output unit of the previous-stage gate driving unit.

16. The gate driving circuit according to claim 15, wherein the fourth control unit further comprises a first switch unit and a second switch unit;
the first switch unit is connected to the first plate of the third storage unit and the high-potential power line, and is configured to pull up the initial voltage signal stored in the third storage unit;
the second switch unit is connected to the second plate of the third storage unit, and is configured to control and output the second pulse signal based on a voltage signal stored in the third storage unit.

17. A display panel, comprising a gate driving circuit, wherein the gate driving circuit comprises a plurality of gate driving units connected in cascades, and each of the gate driving units at least comprises:
a cascade driving unit, connected to a previous-stage gate driving unit;
a first output unit, connected to the cascade driving unit and configured to output a first pulse signal, wherein the first pulse signal is a low-potential pulse signal with a normal high potential;
a second output unit, connected to the cascade driving unit and configured to output a second pulse signal, wherein the second pulse signal is a high-potential pulse signal with a normal low potential.

18. The display panel according to claim 17, wherein the cascade driving unit is connected to a first output unit of the previous-stage gate driving unit.

19. The display panel according to claim 18, wherein
the first output unit comprises a first control unit and a second control unit; an input terminal of the first control unit is connected to a low-potential power line, an input terminal of the second control unit is connected to a high-potential power line, and control terminals of the first control unit and the second control unit are connected to the cascade driving unit; the cascade driving unit is configured to control the first control unit and the second control unit to be alternately turned on, controlling the first output unit to output the first pulse signal;
the second output unit comprises a third control unit and a fourth control unit; an input terminal of the third control unit is connected to the low-potential power line, an input terminal of the fourth control unit is connected to the high-potential power line, and control terminals of the third control unit and the fourth control unit are connected to the cascade driving unit; the cascade driving unit is configured to control the third control unit and the fourth control unit to be alternately turned on, controlling the second output unit to output the second pulse signal.

20. The display panel according to claim 19, wherein the second control unit comprises a first sub-control unit and a second sub-control unit, input terminals of the first sub-control unit and the second sub-control unit are both connected to the high-potential power line, and control terminals of the first sub-control unit and the second sub-control unit are both connected to the cascade driving unit, controlling the first output unit to output the first pulse signal.
